(19) United States
(12) Patent Application Publication
(10) Pub. No.: US 2016/0159481 A1
(43) Pub. Date: Jun. 9, 2016

(54) PASSENGER SEAT WITH FULL SEATBACK VIDEO DISPLAY

(71) Applicant: B/E Aerospace, Inc., Wellington, FL (US)

(72) Inventors: Kosta Gianakopoulos, Highland Village, TX (US); Alexander Nicholas Pozzi, Winston-Salem, NC (US); Glenn Allen Johnson, Rural Hall, NC (US)

(21) Appl. No.: 14/955,332

(22) Filed: Dec. 1, 2015

Related U.S. Application Data
(60) Provisional application No. 62/087,396, filed on Dec. 4, 2014.

(51) Int. Cl. B64D 11/00; B64D 11/06

(52) U.S. Cl. CPC B64D 11/00151; B64D 11/064; B64D 11/0636

(57) ABSTRACT

A passenger seat for an airliner including a seat bottom, a seatback pivotally attached to the seat bottom such that the seatback is configured to pivot relative to the seat bottom between an upright sitting position and a reclined sitting position, and at least one video monitor mounted to a back of the seatback in a position viewable by a passenger seated aft of the passenger seat, the at least one video monitor dimensioned to cover more than 50% of the back of the seatback.

### CROSS-REFERENCE TO RELATED APPLICATION

This application claims priority from U.S. Application No. 62/087,396 filed Dec. 4, 2015, the contents of which are incorporated by reference herein.

### TECHNICAL FIELD AND BACKGROUND OF THE INVENTION

The present invention relates generally to a seatback video display, and more particularly, to a video display dimensioned to cover substantially the entirety of the seatback of a passenger seat and an airliner passenger seat having an integrated video display dimensioned to cover substantially the entirety of the seatback thereof.

The prior art includes various types of video monitors small enough to fit into or onto the rear of a passenger seat headrest or the upper part of the seatback for viewing by passengers seated aft of the passenger seat. These seatback monitors occupy a relatively small area of the upper seatback. Larger monitors have also been mounted on bulkheads and monuments in passenger vehicles such as airliners. Technical advances and substantially lower cost and weight in flat and curved panel video systems now permit larger, thin flat panel video monitors to be produced that can be installed onto seatbacks such that more of the seatback area is covered by a monitor.

In particular, curved screens are promoted as providing an immersive experience, and allowing a wider field of view. The optimal position for viewing a curved monitor is directly along the central axis of the monitor with the central point of the screen at eye level. Viewers seated in any other position come to experience degradations in picture quality ranging anywhere from minor to severe, the most notable being what is termed trapezoidal distortion.

It has been proposed that curved screens allow greater range in satisfactory viewing angles and offer minimal trapezoidal distortion as compared to flat screens. This may be particularly important when the viewer is constrained in his or her movement in relation to the optimal viewing angle, as may the case in various types of transportation vehicles such as commercial airliners.

These advances in the design of video monitors have resulted in advantages that include reduced power consumption, enhanced image quality and the ability in some systems to curve the screen to provide an improved viewing angle and less distortion. Using these new monitors can provide higher quality entertainment and information that can be customized for a personalized and immersive experience for the passenger seated aft of the seatback on which the monitors are mounted.

### BRIEF SUMMARY OF THE INVENTION

It is therefore an object of the invention to provide a video monitor or display that covers substantially all of a predetermined area of a vehicle passenger seatback.

It is another object of the invention to provide one or more video monitors that collectively cover substantially all of a predetermined area of a vehicle passenger seatback.

It is yet another object of the invention to provide one or more video monitors that cover substantially all of a predetermined area of a vehicle passenger seatback, and that can be mounted in various ways and orientations to meet both passenger and operator requirements.

It is yet another object of the invention to provide multiple video monitors that collectively cover substantially all of a vehicle passenger seatback.

These and other objects and advantages of the present invention are achieved by providing a passenger seat for an airliner including a seat bottom, a seatback pivotally attached to the seat bottom such that the seatback is configured to pivot relative to the seat bottom between an upright sitting position and a reclined sitting position, and at least one video monitor mounted to a back of the seatback in a position viewable by a passenger seated aft of the passenger seat, the at least one video monitor dimensioned to cover more than 50% of the back of the seatback.

In a further aspect, the at least one video monitor may be dimensioned to cover more than 75% of the back of the seatback.

In a further aspect, the at least one video monitor may be dimensioned to cover more than 90% of the back of the seatback.

In a further aspect, the at least one video monitor may be dimensioned to cover the back of the seatback from top-to-bottom and left-to-right.

In a further aspect, the passenger seat may include a single video monitor dimensioned to cover more than 50% of the back of the seatback.

In a further aspect, the passenger seat may include a first video monitor and a second video collectively dimensioned to cover more than 50% of the back of the seatback.

In a further aspect, the first video monitor may be mounted to the back of the seatback above the second video monitor, and wherein the first video monitor may be pivotally attached along a top edge thereof to the seatback and a bottom edge thereof may be free from attachment to the seatback such that the bottom edge may be free to rotate away from the seatback when the seatback is in the reclined sitting position.

In a further aspect, the second video monitor may be fixed to the seatback and may move therewith as the seatback reclines.

In a further aspect, the passenger seat may include a pocket attached to a rear of the seat bottom and a recess defined in the back of the seatback below the at least one video monitor providing access into the pocket.

According to another embodiment of the invention, the present invention provides a video display configured to mount to a back of a seatback of a passenger seat, including at least one video monitor mounted to the back of the seatback in a position viewable by a passenger seated aft of the passenger seat, the at least one video monitor dimensioned to cover more than 50% of the back of the seatback.

In a further aspect, the at least one video monitor may be dimensioned to cover more than 75% of the back of the seatback.

In a further aspect, the at least one video monitor may be dimensioned to cover more than 90% of the back of the seatback.

In a further aspect, the video display may include a first video monitor and a second video collectively dimensioned to cover more than 50% of the back of the seatback.

In a further aspect, the first video monitor may be configured to mount to the back of the seatback above the second video monitor, and wherein the first video monitor may be configured to pivotally attach along a top edge thereof to the seatback and a bottom edge thereof may be free from attachment to the seatback such that the bottom edge may be free to rotate away from the seatback when the seatback is reclined.

In a further aspect, the video display may include a pocket arranged below the at least one video monitor, wherein the pocket and the at least one video monitor are mounted within a shroud.

Embodiments of the invention can include one or more or any combination of the above features and configurations.

Additional features, aspects and advantages of the invention will be set forth in the detailed description which follows, and in part will be readily apparent to those skilled in the art from that description or recognized by practicing the invention as described herein. It is to be understood that both the foregoing general description and the following detailed description present various embodiments of the invention, and are intended to provide an overview or framework for understanding the nature and character of the invention as it is claimed. The accompanying drawings are included to provide a further understanding of the invention, and are incorporated in and constitute a part of this specification.

### BRIEF DESCRIPTION OF THE DRAWINGS

These and other features, aspects and advantages of the present invention are better understood when the following detailed description of the invention is read with reference to the accompanying drawings, in which:

FIG. 1 is a rear perspective view of a pair of passenger seats configured with full seatback video monitors according to a first embodiment of the invention;

FIG. 2 shows one of the passenger seats of FIG. 1 in a reclined sitting position;

FIG. 3 is a rear perspective view of a passenger seat configured with a full seatback video monitor according to a second embodiment of the invention; and

FIG. 4 is a rear perspective view of a passenger seat configured with a full seatback video monitor according to a third embodiment of the invention.

### DETAILED DESCRIPTION OF THE INVENTION

The present invention will now be described more fully hereinafter with reference to the accompanying drawings in which exemplary embodiments of the invention are shown. However, the invention may be embodied in many different forms and should not be construed as limited to the representative embodiments set forth herein. The exemplary embodiments are provided so that this disclosure will be both thorough and complete, and will fully convey the scope of the invention and enable one of ordinary skill in the art to make, use and practice the invention. Like reference numbers refer to like elements throughout the various drawings.

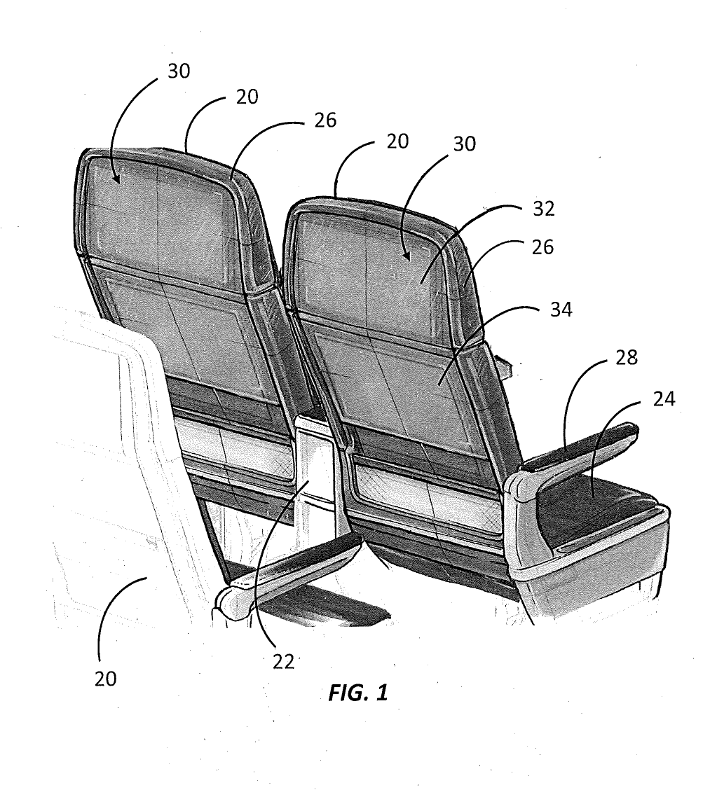

FIG. 1 shows a pair of laterally-adjacent passenger seats 20 of the type that may be found in a commercial airliner. The passenger seats 20 are separated by a console 22, which may be shared and serve as an armrest. While a row of two side-by-side passenger seats are shown positioned directly forward of a like passenger seat of an aft-positioned row, it is envisioned that rows may include a single passenger seat or more than two passenger seats. Thus, the number of rows, number of seats within each row, and seat types in adjacent rows is not critical to the understanding and implementation of the present invention and may vary.

The passenger seats 20 may be identical in all material respects or may vary. Each of the passenger seats 20 generally includes a seat bottom 24 and a seatback 26 configured recline to selectively achieve various sitting positions between fully upright and fully reclined. As shown, the seatbacks 26 are capable of reclining to a degree, but are not capable of reclining to horizontal based on the closeness of the seat bottom of the seat in the aft-positioned row. Each passenger seat 20 may be equipped with a dedicated armrest 28 on the side(s) of the seat adjacent the aisle(s). It is envisioned that the seats may be mounted in any orientation within the cabin, and the video system described in the following embodiments is applicable to passenger seats for all classes of service.

The passenger seats 20 can be mounted to a frame that includes legs that mount to the deck of the cabin in a conventional manner. Any one of, or all of, the seat bottoms 24, seatbacks 26, and armrests 28 may be cushioned and upholstered for comfort and aesthetics. Each of the passenger seats 20 may further include a headrest and deployable leg rest, each of which may be adjustable for added comfort. Cabling associated with actuators and seat recline control may be housed within the seats and concealed from view beneath shrouding and/or upholstering. Cabling, wiring, attachments points, etc. associated with the seatback video displays described herein may also be concealed within the seat and covered with shrouding and/or upholstering.

In all seatback video display embodiments described herein, the entirety of, or substantially the entirety of, the backside of the seatback 26 of the passenger seat 20 is covered with one or more video displays for viewing by an aft-seated passenger or group of passengers in an adjacent row. As used herein, the term “display” is used interchangeably with the term “monitor”, and is intended to generically mean any and all types of electronic videos displays now known or hereafter invented, some of which include light-emitting diode (LED), liquid crystal (LCD), organic light-emitting diode (OLED), and plasma displays.

FIG. 1 shows a seatback video display 30 according to a first embodiment of the invention. Seatback video display 30 may be configured to be attached to the seatback 26 and removable therefrom, or may be incorporated into the seatback construction such that the seatback video display 30 forms a permanent, integrated part of the seatback 26. As shown, the seatback video display 30 includes a first monitor 32 and a second monitor 34 that together cover substantially the entirety of the surface area of the back of the seatback 26. The first video monitor 32 is arranged to cover an upper portion of the seatback including the headrest, and the second video monitor is arranged to cover a lower portion of the seatback supporting the torso. Thus, the first and second monitors 32, 34 are arranged one above the other when the seatback 26 is in an upright sitting position.

The seatback 26 has a slight curvature from top-to-bottom and therefore defines an angle between the torso and headrest portions thereof. As such, the first and second monitors 32, 34 can be mounted with a slight angle therebetween in order to follow the curvature of the seatback 26 from top-to-bottom. The angle between the first and second monitors 32, 34 is illustrated by the angle symbol shown in FIG. 1. In an alternative embodiment, while the front of the seatback may be curved from top-to-bottom for comfort, the back of the seatback may be straight such that the faces of the first and second monitors 32, 34 reside in the same plane.

The first and second monitors 32, 34 may be housed within a common shroud or may each have their own dedicated shroud. Separate shrouds may be detached to accommodate pivoting headrest movement when the passenger seat is so equipped.

The first and second monitors 32, 34 may be configured to simultaneously broadcast content from one single source or “feed” to provide one large, combined viewing screen. The first and second monitors 32, 34 may also be configured to simultaneously broadcast content from more than one source or “feed” simultaneously such that the first or “top” monitor 32 can broadcast content from one source while the second or “bottom” monitor 34 can broadcast content from a second, different source, thus providing two smaller, separate video screens. The first and second monitors 32, 34 can be independently or collectively controlled such that one monitor or both can be used at a time. In one aspect, the top monitor 32 may be used to broadcast safety features during pre-flight while the bottom monitor 34 is powered down to minimize power consumption, while both monitors may be powered during flight depending on the content being broadcast.

In one aspect, the monitors are full-frame, meaning that the viewable portion of each monitor extends to substantially the edge thereof such that the viewing experience is seamless and there are no gaps between viewable portions of adjacent monitors. While two monitors 32, 34 are shown in FIG. 1, it is envisioned that a single monitor may cover substantially the entirety of the surface area of the back of the seatback 26, or more than two monitors may collectively cover substantially the entirety of the surface area of the seatback. Controls for controlling the monitors 32, 34 and content broadcast on the monitors may be located in the seatback below the monitors, in the armrests or console of the seat directly aft of the monitors, or in another location in the vicinity of the monitors. The monitors 32, 34 can be passenger and/or flight crew controllable.

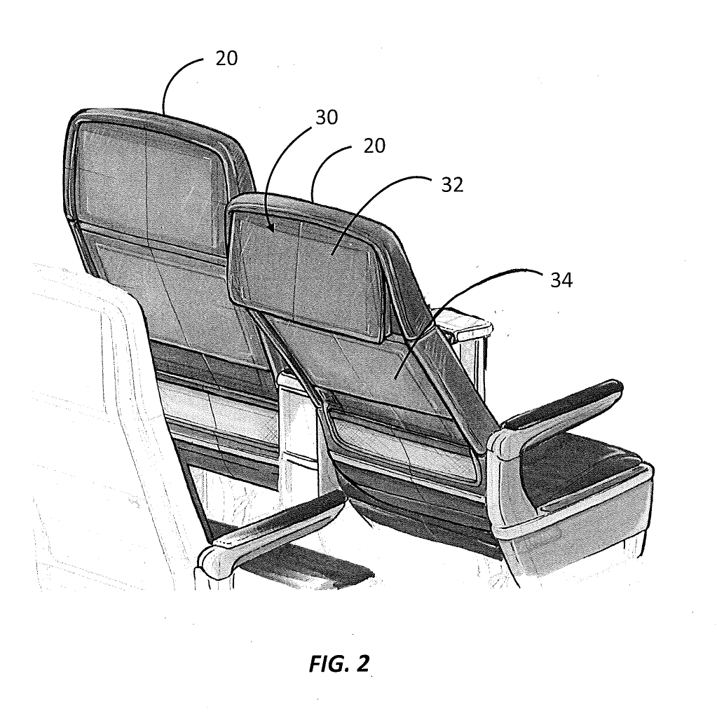

FIG. 2 shows one of the passengers seats 20 with the seatback 26 thereof reclined to achieve a reclined sitting position. As apparent in FIG. 1, the top monitor 32 is configured to pivot relative to the seatback 26 as the seatback reclines to maintain a consistent viewing angle for the aft-seated passenger directly facing the monitor regardless of the angle of the seatback 26 to which the monitor is attached. To achieve such pivoting motion, the top monitor 32 may be pivotally attached along a top edge thereof such that the bottom edge of the monitor is free to rotate outward away from the seatback 26 as the seatback reclines. Adjustability may be stepless or stepped and may include any type of conventional mechanism for holding the monitor in place and resisting unintentional movements and forces.

As shown in FIG. 2, the second or bottom monitor 34 is not pivotally attached to the seatback 26 and therefore moves with the seatback recline, although the second monitor 34 can be pivotally attached to the seatback in the same manner as the first or top monitor 32. Thus, the two monitors 32, 34 can be configured to pivot together as the seatback reclines.

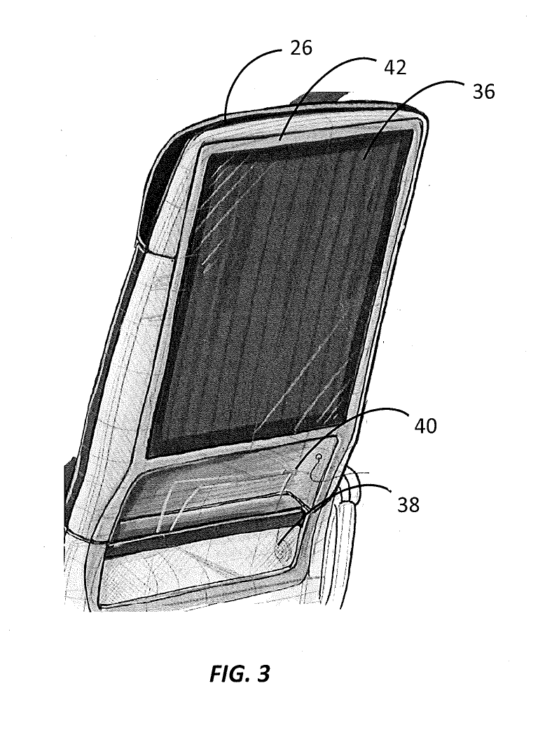

FIG. 3 shows another embodiment of a full seatback video display according to a second embodiment of the invention. In this embodiment, the display includes one large, single monitor 36 that covers the entirety, or substantially the entirety of, the back of the seatback 26, from top-to-bottom and left-to-right. A pocket 38 can be positioned below the single monitor 36, as well as monitor and broadcast content controls. The pocket 38 may also be provided on the rear of the seat bottom with an opening to the pocket formed as a recess 40 in the lower end of the back of the seatback 26 immediately below the single monitor 36. The single monitor 36, pocket 38 and recess 40 may be housed within a common shroud 42.

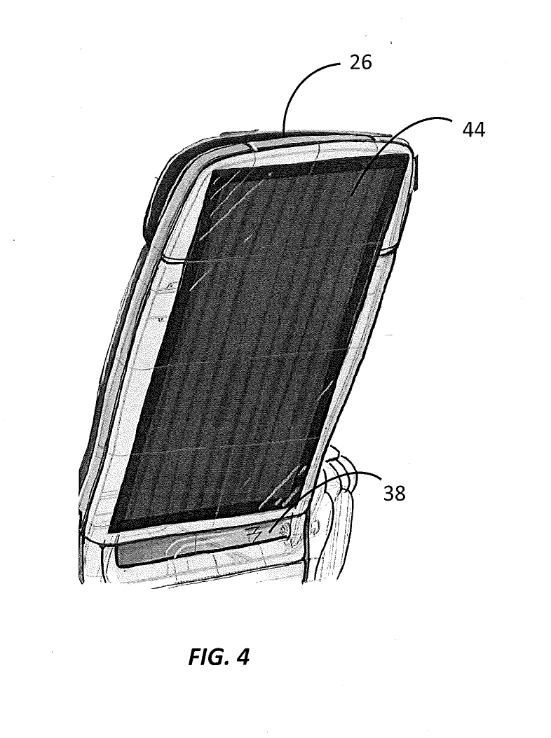

FIG. 4 shows yet a third embodiment of a full seatback video display. In this embodiment, the display again includes one large single display 44 that spans the entirety of the height and substantially the full width of the back of the seatback 26. Compared to the second embodiment described above, the third embodiment lacks the recess in the seatback for pocket access. A pocket 38 may also be provided on the rear of the seat bottom.

In all of the above described embodiments, broadcast information and entertainment can be customized to suit the requirements of the passenger. For example, a passenger may prefer to have a movie displayed on an upper video monitor, while a flight progress map, destination information or other preferences displayed on a lower video monitor, or vice versa. In the case of two monitors on the seatback, both monitors can be fixed or mounted on a suitable mechanism to allow the monitors to tilted or rotated to adjust the viewing angle thereof. Single monitors may be mounted in a fixed position or mounted to tilt and/or rotate. In all embodiments the monitors may be flat or curved. Several arrangements may be furnished to permit use of a deployable tray table. For example, a tray table may be stowed below the lower video monitor in the area of the seat bottom. Alternatively, one of the video monitors may be mounted on the bottom of the tray table so that the upper video monitor is viewable when the tray table is stowed, and the lower video monitor viewable regardless of the position of the tray table. Yet another alternative is to provide a tray table that stows in an armrest and deploys by lifting the tray table out of the arm rest and rotating into a position in front of the seat occupant.

In certain aspects, the at least one video monitor is dimensioned to cover more than 50% of the surface area of the back of the seatback, preferably more than 75% of the surface area of the back of the seatback, and even more preferably more than 90% of the surface area of the back of the seatback.

While the foregoing description provides embodiments of the invention by way of example only, it is envisioned that other embodiments may perform similar functions and/or achieve similar results. Any and all such equivalent embodiments and examples are within the scope of the present invention and are intended to be covered by the appended claims.

What is claimed is:

1. A passenger seat for an airliner, comprising:
a seat bottom;
a seatback pivotally attached to the seat bottom such that the seatback is configured to pivot relative to the seat bottom between an upright sitting position and a reclined sitting position; and
at least one video monitor mounted to a back of the seatback in a position viewable by a passenger seated aft of the passenger seat, the at least one video monitor dimensioned to cover more than 50% of the back of the seatback.

2. The passenger seat of claim 1, wherein the at least one video monitor is dimensioned to cover more than 75% of the back of the seatback.

3. The passenger seat of claim 1, wherein the at least one video monitor is dimensioned to cover more than 90% of the back of the seatback.

4. The passenger seat of claim 1, wherein the at least one video monitor is dimensioned to cover the back of the seatback from top-to-bottom and left-to-right.

5. The passenger seat of claim 1, comprising a single video monitor dimensioned to cover more than 50% of the back of the seatback.

6. The passenger seat of claim 1, comprising a first video monitor and a second video collectively dimensioned to cover more than 50% of the back of the seatback.

7. The passenger seat of claim 6, wherein the first video monitor is mounted to the back of the seatback above the second video monitor, and wherein the first video monitor is pivotally attached along a top edge thereof to the seatback and a bottom edge thereof is free from attachment to the seatback such that the bottom edge is free to rotate away from the seatback when the seatback is in the reclined sitting position.

8. The passenger seat of claim 6, wherein the second video monitor is fixed to the seatback and moves therewith as the seatback reclines.

9. The passenger seat of claim 1, further comprising a pocket attached to a rear of the seat bottom and a recess defined in the back of the seatback below the at least one video monitor providing access into the pocket.

10. A video display configured to mount to a back of a seatback of a passenger seat, comprising:
at least one video monitor mounted to the back of the seatback in a position viewable by a passenger seated aft of the passenger seat, the at least one video monitor dimensioned to cover more than 50% of the back of the seatback.

11. The video display of claim 10, wherein the at least one video monitor is dimensioned to cover more than 75% of the back of the seatback.

12. The video display of claim 10, wherein the at least one video monitor is dimensioned to cover more than 90% of the back of the seatback.

13. The video display of claim 10, comprising a first video monitor and a second video collectively dimensioned to cover more than 50% of the back of the seatback.

14. The video display of claim 13, wherein the first video monitor is configured to mount to the back of the seatback above the second video monitor, and wherein the first video monitor is configured to pivotally attach along a top edge thereof to the seatback and a bottom edge thereof is free from attachment to the seatback such that the bottom edge is free to rotate away from the seatback when the seatback is reclined.

15. The video display of claim 10, further comprising a pocket arranged below the at least one video monitor, wherein the pocket and the at least one video monitor are mounted within a shroud.
